(19) United States
(12) Patent Application Publication
(10) Pub. No.: US 2016/0055770 A1
(43) Pub. Date: Feb. 25, 2016

(54) CONVERTING DEVICE AND DISPLAYING SYSTEM

(71) Applicant: TENDYRON CORPORATION, Beijing (CN)

(72) Inventor: Dongsheng LI, Beijing (CN)

(21) Appl. No.: 14/779,296

(22) PCT Filed: Feb. 25, 2014
(86) PCT No.: PCT/CN2014/072504

§ 371 Date: Sep. 22, 2015

(30) Foreign Application Priority Data
Apr. 27, 2013 (CN) 201310153247.2

(51) Int. Cl. G09C 5/00

(52) U.S. Cl. CPC G09C 5/00

(57) ABSTRACT

A converting device and a displaying system is described, which can include: a first transmitting module, a first detecting module, a second detecting module, a conversion module, a first security module, and a second transmission module. The first transmitting module receives first information; the first detecting module determines whether the first information is encrypted information; if the first information is not encrypted, the second detecting module determines whether the first information is in a preset format; if yes, the first security module encrypts the first information to obtain first encrypted data and sends the first encrypted data to the second transmission module; and if not, the converting module converts the first information into first converted information in the preset format, and the first security module encrypts the first conversion information to obtain first encrypted and converted data and sends the first encrypted and converted data to the second transmission module.

### FIELD

Embodiments of the present disclosure generally relate to an electronic technology field, and more particularly, to a converting device and a displaying system.

### BACKGROUND

With the generation and development of the smart products, such as MP3 players, tablet computers, smart phones, more flexible requirement on browsing data including video, audio, and text is presented. Thus, the glasses capable of receiving and displaying data sent by a terminal are designed in the related art, which significantly satisfies the requirement of data browsing.

However, the existing glasses capable of receiving and displaying data generally directly display any data transmitted by the terminal. Since the data transmission is transparent, the safety of the data transmission cannot be guaranteed when transmitting the data related to privacy, such that the hidden danger of leaking privacy may be generated.

### SUMMARY

The present disclosure seeks to solve at least one of the above problems.

Embodiments of a first aspect of the present disclosure provide a converting device, and the converting device includes: a first transmitting module, a first detecting module, a second detecting module, a converting module, a first security module and a second transmitting module; in which

the first transmitting module is configured to establish a communication connection and to receive a first information after establishing the communication connection; the first detecting module is configured to judge whether the first information is an encrypted information after the first information is received by the first transmitting module;

if the first information is not encrypted information, the first detecting module sends the first information to the second detecting module for being detected, the second detecting module is configured to judge whether the first information is an information in a preset format after receiving the first information;
if the first information is the information in the preset format, the second detecting module sends the first information to the first security module for being encrypted, and the first security module encrypts the first information to obtain a first encrypted data and sends the first encrypted data to the second transmitting module for being transmitted; and/or
if the first information is not the information in the preset format, the second detecting module sends the first information to the converting module for being converted, the converting module converts the first information into a first converted information in a preset format and sends the first converted information to the first security module for being encrypted, and the first security module encrypts the first converted information to obtain a first encrypted and converted data and sends the first encrypted and converted data to the second transmitting module for being transmitted; and/or

if the first information is encrypted information, the first detecting module sends the first information to the first security module for being decrypted, the first security module decrypts the first information to obtain a first decrypted information and sends the first decrypted information to the second detecting module for being detected, the second detecting module is configured to judge whether the first decrypted information is an information in a preset format after receiving the first decrypted information;
if the first decrypted information is the information in the preset format, the second detecting module sends the first decrypted information to the first security module for being encrypted, and the first security module encrypts the first decrypted information to obtain a second encrypted data and sends the second encrypted data to the second transmitting module for being transmitted; and/or
if the first decrypted information is not the information in the preset format, the second detecting module sends the first decrypted information to the converting module for being converted, the converting module converts the first decrypted information into a second converted information in a preset format and sends the second converted information to the first security module for being encrypted, and the first security module encrypts the second converted information to obtain a second encrypted and converted data and sends the second encrypted and converted data to the second transmitting module for being transmitted.

Moreover, the second transmitting module of the converting device is further configured to receive a second data, and to send the second data to the first security module; the first security module decrypts the second data to obtain a second decrypted information after receiving the second data, and sends the second decrypted information to the first transmitting module for being transmitted; or the second transmitting module of the converting device is further configured to receive a second data and to send the second data to the first security module; the first security module decrypts the second data to obtain a second decrypted information after receiving the second data, encrypts the second decrypted information to obtain a third encrypted data, and sends the third encrypted data to the first transmitting module for being transmitted.

Moreover, the first security module is further configured to at least sign a signature on the first encrypted data so as to obtain a first signature data and to send the first signature data to the second transmitting module for being transmitted; or the first security module is further configured to at least sign a signature on the first encrypted and converted data so as to obtain a first signature data and to send the first signature data to the second transmitting module for being transmitted; or the first security module is further configured to at least sign a signature on the second encrypted data so as to obtain a first signature data and to send the first signature data to the second transmitting module for being transmitted; or the first security module is further configured to at least sign a signature on the second encrypted and converted data so as to obtain a first signature data and to send the first signature data to the second transmitting module for being transmitted.

Moreover, the first security module is further configured to at least sign a signature on the first information which is not encrypted information so as to obtain a first signature data, and to send the first signature data to the second transmitting module for being transmitted; or the first security module is further configured to at least sign a signature on the first converted information so as to obtain a first signature data, and to send the first signature data to the second transmitting module for being transmitted; or the first security module is further configured to at least sign a signature on the first decrypted information so as to obtain a first signature data, and to send the first signature data to the second transmitting module for being transmitted; or the first security module is further configured to at least sign a signature on the second converted information so as to obtain a first signature data, and to send the first signature data to the second transmitting module for being transmitted.

Moreover, the second transmitting module is further configured to receive a second signature data when receiving the second data, and to send the second signature data to the first security module; the first security module verifies the second signature data after receiving the second data and the second signature data, decrypts the second data to obtain the second decrypted information after the second signature data is successfully verified, and sends the second decrypted information to the first transmitting module for being transmitted; or the second transmitting module is further configured to receive a second signature data when receiving the second data, and to send the second signature data to the first security module; the first security module verifies the second signature data after receiving the second data and the second signature data, decrypts the second data to obtain the second decrypted information after the second signature data is successfully verified, encrypts the second decrypted information to obtain the third encrypted data and sends the third encrypted data to the first transmitting module for being transmitted.

Moreover, the second transmitting module is further configured to receive a second signature data when receiving the second data, and to send the second signature data to the first security module; the first security module decrypts the second data to obtain the second decrypted information after receiving the second data and the second signature data, verifies the second signature data after obtaining the second decrypted information, and sends the second decrypted information to the first transmitting module for being transmitted after the second signature data is successfully verified; or the second transmitting module is further configured to receive a second signature data when receiving the second data, and to send the second signature data to the first security module; the first security module decrypts the second data to obtain the second decrypted information after receiving the second data and the second signature data, verifies the second signature data after obtaining the second decrypted information, encrypts the second decrypted information to obtain the third encrypted data after the second signature data is successfully verified, and sends the third encrypted data to the first transmitting module for being transmitted.

Moreover, the first transmitting module transmits data in any of following modes: an audio transmission mode, a USB transmission mode, a serial transmission mode, an NFC transmission mode, a Blue Tooth transmission mode, an infrared transmission mode, an optical transmission mode, a WIFI transmission mode, a GPRS transmission mode, a 3G transmission mode, and a GSM transmission mode; and the second transmitting module transmits data in any of following modes: an audio transmission mode, a USB transmission mode, a serial transmission mode, an NFC transmission mode, a Blue Tooth transmission mode, an infrared transmission mode, an optical transmission mode, a WIFI transmission mode, a GPRS transmission mode, a 3G transmission mode, and a GSM transmission mode.

Embodiments of a second aspect of the present disclosure provide a displaying system, and the displaying system includes a pair of glasses and the converting device according to embodiments of the first aspect of the present disclosure; the pair of glasses comprises a body of glasses, a displaying module disposed on the body, a second security module disposed on the body and a communication module disposed on the body;

the communication module is configured to establish a communication connection with the second transmitting module of the converting device and to receive the first encrypted data after establishing the communication connection; the second security module is configured to decrypt the first encrypted data so as to obtain the first information which is not encrypted information after the first encrypted data is received by the communication module, and further to send a displaying instruction to the displaying module after obtaining the first information which is not encrypted information; the displaying module is configured to receive the displaying instruction, and to display according to the displaying instruction and the first information which is not encrypted information;

or

the communication module is configured to establish a communication connection with the second transmitting module of the converting device and to receive the first encrypted and converted data after establishing the communication connection; the second security module is configured to decrypt the first encrypted and converted data so as to obtain the first converted information after the first encrypted and converted data is received by the communication module, and further to send a displaying instruction to the displaying module after obtaining the first converted information; the displaying module is configured to receive the displaying instruction, and to display according to the displaying instruction and the first converted information;

or

the communication module is configured to establish a communication connection with the second transmitting module of the converting device and to receive the second encrypted data after establishing the communication connection; the second security module is configured to decrypt the second encrypted data so as to obtain the first decrypted information after the second encrypted data is received by the communication module, and further to send a displaying instruction to the displaying module after obtaining the first decrypted information; the displaying module is configured to receive the displaying instruction, and to display according to the displaying instruction and the first decrypted information;

or

the communication module is configured to establish a communication connection with the second transmitting module of the converting device and to receive the second encrypted and converted data after establishing the communication connection; the second security module is configured to decrypt the second encrypted and converted data so as to obtain the second converted information after the second encrypted and converted data is received by the communication module, and further to send a displaying instruction to the displaying module after obtaining the second converted information; the displaying module is configured to receive the displaying instruction, and to display according to the displaying instruction and the second converted information.

Moreover, the second security module is further configured to receive an input instruction, to generate an information to be output according to the input instruction, and to encrypt the information to be output so as to obtain the second data; the communication module is further configured to transmit the second data after the second data is obtained by the second security module.

Moreover, the communication module is further configured to receive the first signature data when receiving the first encrypted data; the second security module is configured to verify the first signature data after the first signature data is received by the communication module, and to decrypt the first encrypted data so as to obtain the first information which is not encrypted information after the first signature data is successfully verified;

or

the communication module is further configured to receive the first signature data when receiving the first encrypted and converted data; the second security module is configured to verify the first signature data after the first signature data is received by the communication module, and to decrypt the first encrypted and converted data so as to obtain the first converted data after the first signature data is successfully verified;

or

the communication module is further configured to receive the first signature data when receiving the second encrypted data; the second security module is configured to verify the first signature data after the first signature data is received by the communication module, and to decrypt the second encrypted data so as to obtain the first decrypted information after the first signature data is successfully verified;

or

the communication module is further configured to receive the first signature data when receiving the second encrypted and converted data; the second security module is configured to verify the first signature data after the first signature data is received by the communication module, and to decrypt the second encrypted and converted data so as to obtain the second converted data after the first signature data is successfully verified.

Moreover, the communication module is further configured to receive the first signature data when receiving the first encrypted data; the second security module is configured to decrypt the first encrypted data so as to obtain the first information which is not encrypted information after the first signature data is received by the communication module, to verify the first signature data after obtaining the first information which is not encrypted information, and further to send a displaying instruction to the displaying module after the first signature data is successfully verified;

or

the communication module is further configured to receive the first signature data when receiving the first encrypted and converted data; the second security module is configured to decrypt the first encrypted and converted data so as to obtain the first converted information after the first signature data is received by the communication module, to verify the first signature data after obtaining the first converted information, and further to send a displaying instruction to the displaying module after the first signature data is successfully verified;

or

the communication module is further configured to receive the first signature data when receiving the second encrypted data; the second security module is configured to decrypt the second encrypted data so as to obtain the first decrypted information after the first signature data is received by the communication module, to verify the first signature data after obtaining the first decrypted information, and further to send a displaying instruction to the displaying module after the first signature data is successfully verified;

or

the communication module is further configured to receive the first signature data when receiving the second encrypted and converted data; the second security module is configured to decrypt the second encrypted and converted data so as to obtain the second converted information after the first signature data is received by the communication module, to verify the first signature data after obtaining the second converted information, and further to send a displaying instruction to the displaying module after the first signature data is successfully verified.

Moreover, the second security module is further configured to at least sign a signature on the information to be output so as to obtain the second signature data after generating the information to be output; the communication module is further configured to transmit the second signature data after the second signature data is obtained by the second security module.

Moreover, the second security module is further configured to at least sign a signature on the second data so as to obtain the second signature data; the communication module is further configured to transmit the second signature data after the second signature data is obtained by the second security module.

Moreover, the body is provided with a button and the second security module receives the input instruction via the button.

Moreover, the communication module transmits data to the second transmitting module in any of following modes: an audio transmission mode, a USB transmission mode, a serial transmission mode, an NFC transmission mode, a Blue Tooth transmission mode, an infrared transmission mode, an optical transmission mode, a WIFI transmission mode, a GPRS transmission mode, a 3G transmission mode, and a GSM transmission mode.

Moreover, the displaying system further includes a terminal which is configured to establish a communication connection with the first transmitting module of the converting device, and to send the first information to the first transmitting module after establishing the communication connection.

Moreover, the terminal is further configured to receive the second decrypted information transmitted by the first transmitting module; or the terminal is further configured to receive the third encrypted data transmitted by the first transmitting module.

With the converting device and the displaying system according to the present disclosure, since the data is encrypted by the converting device during the process of data transmission, the safety of the data transmission may be guaranteed. In addition, with the glasses according to the present disclosure, the encrypted data transmitted by the converting device is decrypted by the second security module in local, such that the safety of the data transmission is further guaranteed, a remote attack from a hacker may be avoided to a maximum extent, and a hidden danger caused by sending data decrypted by other decrypting device to the glasses is eliminated. Moreover, the information output by the glasses is transmitted by the communication module after being encrypted by the second security module of the glasses, such that the safety of the data output by the glasses may be guaranteed. Further, on one hand, a signature may be signed on the data transmitted by the converting device and the glasses verify the signature, on the other hand, a signature may be signed on the data output by the glasses and the converting device verifies the signature, such that the authenticity of the identities of the converting device and the glasses is guaranteed, thus further improving the safety of the data transmission.

### BRIEF DESCRIPTION OF THE DRAWINGS

In order to make technical solutions according to embodiments of the present disclosure more apparent, drawings used in descriptions of the embodiments will be illustrated in the following. Obviously, the drawings to be illustrated in the following only represent some embodiments of the present disclosure, and other drawings can be obtained according to these drawings by those having ordinary skills in the related art without making creative labors.

FIG. 1 is a block diagram of a displaying system according to an embodiment of the present disclosure.

### DETAILED DESCRIPTION

The technical solution according to embodiments of the present disclosure will be described in the following with reference to drawings of the embodiments of the present disclosure. Obviously, the embodiments to be described only are some embodiments of the present disclosure, rather than all embodiments. Based on these embodiments of the present disclosure, other embodiments obtained by those having ordinary skills in the related art without making creative labors all fall into a protection scope of the present disclosure.

In the description of the present disclosure, it is to be understood that relative terms such as “central”, “longitudinal”, “lateral”, “up”, “down”, “front”, “rear”, “right”, “left”, “vertical”, “horizontal”, “bottom”, “top”, “inner”, “outer” as well as derivative thereof should be construed to refer to the orientation as then described or as shown in the drawings under discussion for simplifying the description of the present disclosure, but do not alone indicate or imply that the device or element referred to must have a particular orientation. Moreover, it is not required that the present disclosure is constructed or operated in a particular orientation, and thus embodiments of the present disclosure are not limited to these. In addition, In addition, terms such as “first” and “second” are used herein for purposes of description and are not intended to indicate or imply relative importance or significance.

In the description of the present disclosure, unless specified or limited otherwise, it should be noted that, terms “mounted,” “connected” and “coupled” may be understood broadly, such as permanent connection or detachable connection, electronic connection or mechanical connection, direct connection or indirect connection via intermediary, inner communication or interaction between two elements. These having ordinary skills in the art should understand the specific meanings in the present disclosure according to specific situations.

Embodiments of the present disclosure will be described in the following with reference to the drawings.

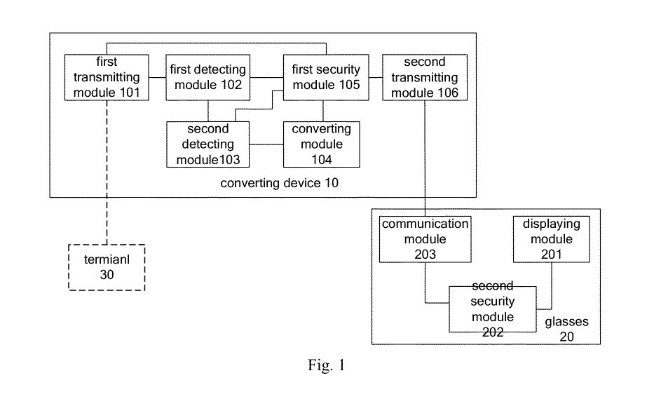

FIG. 1 is a block diagram of a displaying system according to an embodiment of the present disclosure. As shown in FIG. 1, the displaying system includes a converting device 10, and a pair of glasses 20. Moreover, the displaying system may further include a terminal 30. The terminal 30 may be any of the following apparatus: an MP3 player, a smart phone, a tablet computer, a notebook computer, a PC, a USB flash disk or a remote server and so on. Of course, the converting device 10 according to the present disclosure may be configured as a single device provided with different interfaces. For example, the converting device 10 includes interfaces such as an IC card slot, an SD card slot or a card reader, and reads the unencrypted or encrypted documents stored in an apparatus, such as IC card or SD card, which is connected with the converting device 10 via these interfaces.

The converting device 10 may include a first transmitting module 101, a first detecting module 102, a second detecting module 103, a converting module 104, a first security module 105 and a second transmitting module 106.

The first transmitting module 101 may establish a communication connection via the following ways.

Wired transmission mode: an audio transmission mode, a USB transmission mode, a serial transmission mode and so on.

Wireless transmission mode: an NFC transmission mode, a Blue Tooth transmission mode, an infrared transmission mode, an optical transmission mode, a WIFI transmission mode, a GPRS transmission mode, a 3G transmission mode, and a GSM transmission mode and so on. With the wireless transmission mode, the number of the interface may be reduced and the volume of the converting device 10 may be reduced. Thus, the converting device 10 is convenient to be used and be carried.

The second transmitting module 106 may establish a communication connection via the following ways.

Wired transmission mode: an audio transmission mode, a USB transmission mode, a serial transmission mode and so on.

Wireless transmission mode: an NFC transmission mode, a Blue Tooth transmission mode, an infrared transmission mode, an optical transmission mode, a WIFI transmission mode, a GPRS transmission mode, a 3G transmission mode, and a GSM transmission mode and so on. With the wireless transmission mode, the number of the interface may be reduced and the volume of the converting device 10 may be reduced. Thus, the converting device 10 is convenient to be used and be carried.

The pair of glasses 20 includes a body of glasses. Besides a displaying module 201, a second security module 202 and a communication module 203 may be disposed on the body so as to be carried conveniently. Surely, the displaying module 201 may be disposed on a spectacles frame separately or on a surface of a spectacles lens. If the displaying module 201 is disposed on the surface of the spectacles lens, the user may directly view the displayed content when wearing the pair of glasses 20, which is convenient for the user. Of course, the displaying module 201 may be manufactured as the spectacles lens, in this way the manufacturing process of the glasses 20 is simplified and the practicability of the glasses 20 is enhanced. The second security module 202 and the communication module 203 may be disposed on the spectacles frame separately or inside the spectacles frame. If the second security module 202 and the communication module 203 are disposed inside the spectacles frame, the volume of the pair of glasses 20 may be reduced and the pair of glasses 20 is convenient to be carried and be used.

Specifically, the communication module 203 may establish a communication connection in the following ways.

Wired transmission mode: an audio transmission mode, a USB transmission mode, a serial transmission mode and so on.

Wireless transmission mode: an NFC transmission mode, a Blue Tooth transmission mode, an infrared transmission mode, an optical transmission mode, a WIFI transmission mode, a GPRS transmission mode, a 3G transmission mode, and a GSM transmission mode and so on. With the wireless transmission mode, the number of the interface may be reduced and the volume of the glasses 20 may be reduced. Thus, the glasses 20 are convenient to be used and be carried.

The first transmitting module 101 of the converting device 10 establishes a communication connection with the terminal 30 via a match transmission mode, such that the information sent by the terminal 30 may be received by the first transmitting module 101. The second transmitting module 106 of the converting device 10 may establish a communication connection with the communication module 203 of the glasses 20 via a match transmission mode, such that the information sent by the terminal 30 may be sent to the glasses 20 after being processed.

The terminal 30 is configured to generate a first information, and to send the first information to the first transmitting module 101 of the converting device 10 after establishing the communication connection with the first transmitting module 101. Since the first information sent by the terminal 30 may be unencrypted information or encrypted information, the converting device 10 performs the following processes after receiving the first information.

The first transmitting module 101 is configured to establish a communication connection, and to receive the first information after establishing the communication connection. Specifically, the terminal 30 sends the unencrypted information or encrypted information to the first transmitting module 101 for further processing after the communication connection between the terminal 30 and the first transmitting module 101 is established.

The first detecting module 102 is configured to judge whether the first information is encrypted information after the first information is received by the first transmitting module 101.

If the first information is not encrypted information, the first detecting module 102 sends the first information to the second detecting module 103 for being detected, and the second detecting module 103 is configured to judge whether the first information is information in a preset format after receiving the first information.

If the first information is the information in the preset format, the second detecting module 103 sends the first information to the first security module 105 for being encrypted, and the first security module 105 encrypts the first information so as to obtain a first encrypted data, and sends the first encrypted data to the second transmitting module 106 for being transmitted; and/or if the first information is not the information in the preset format, the second detecting module 103 sends the first information to the converting module 104 for being converted, the converting module 104 converts the first information into a first converted information in the preset format and sends the first converted information to the first security module 105 for being encrypted, and the first security module 105 encrypts the first converted information to obtain a first encrypted and converted data and sends the first encrypted and converted data to the second transmitting module 106 for being transmitted.

And/or, if the first information is encrypted information, the first detecting module 102 sends the first information to the first security module 105 for being decrypted, the first security module 105 decrypts the first information to obtain a first decrypted information and sends the first decrypted information to the second detecting module 103 for being detected, and the second detecting module 103 is configured to judge whether the first decrypted information is information in a preset format after receiving the first decrypted information.

If the first decrypted information is the information in the preset format, the second detecting module 103 sends the first decrypted information to the first security module 105 for being encrypted, and the first security module 105 encrypts the first decrypted information to obtain a second encrypted data and sends the second encrypted data to the second transmitting module 106 for being transmitted; and/or if the first decrypted information is not the information in the preset format, the second detecting module 103 sends the first decrypted information to the converting module 104 for being converted, the converting module 104 converts the first decrypted information into a second converted information in the preset format and sends the second converted information to the first security module 105 for being encrypted, and the first security module 105 encrypts the second converted information to obtain a second encrypted and converted data and sends the second encrypted and converted data to the second transmitting module 106 for being transmitted.

Accordingly, the data is encrypted by the converting device in the process of transmitting. Thus, the safety of the data transmission is ensured.

Of course, in the present disclosure, the converting device 10 may separately perform the process flow based on whether the received first information is encrypted information or not. That is, if the first information is not encrypted information, the converting device 10 may separately execute the process flow of encrypting or encrypting after converting the first information which is not encrypted information; if the first information is encrypted information, the converting device may separately execute the process flow of encrypting after decrypting or converting and encrypting after decrypting the first information which is encrypted information. The converting device 10 may also separately perform the process flow based on whether the first information is the information in the preset format or not. That is, if the first information is the information in the preset format, the converting device 10 may separately execute the process flow of encrypting the first information, and if the first information is not the information in the preset format, the converting device 10 may execute the process flow of encrypting after converting the first information. The converting device 10 may also separately perform the process flow based on whether the first decrypted information is the information in the preset format. That is, if the first decrypted information is the information in the preset format, the converting device 10 may execute the process flow of encrypting the first decrypted information, and if the first decrypted information is not the information in the preset format, the converting device 10 may execute the process flow of encrypting after converting the first information.

If the terminal 30 sends the encrypted information to the converting device 10, the converting device 10 decrypts the encrypted information sent by the terminal 30. In this case, a decryption algorithm of the converting device 10 should match with an encryption algorithm of the terminal 30. Surely, an encryption algorithm by which the converting device 10 encrypts the information to be transmitted to the glasses 20 may be the same as or different from the encryption algorithm adopted by the terminal 30. If the two encryption algorithms are same, the calculation is simplified. If the two encryption algorithms are different, the algorithms may be prevented from being cracking, such that the safety of the data transmission may be further improved.

The converting device 10 converts the information sent by the terminal 30 which is not information in the preset format into the information in the preset format for matching with the glasses 20 that supports the preset format, such that the glasses may display the information correctly.

It should be noted that, the preset format supported by the glasses 20 according to embodiments of the present disclosure may be a coding and decoding format with the highest coding and decoding efficiency. For example, the preset format of the document supported by the glasses 20 is “TXT” format, and the preset format of the image supported by the glasses 20 is “ESC” format. Of course, different kinds (such as audio mode, video mode) of coding and decoding formats with highest coding and decoding efficiency may be supported, which are not list herein. By adopting coding and decoding formats with highest coding and decoding efficiency as the preset format, the speed of processing the data by the glasses may be increased. Therefore, the glasses 20 may receive four kinds of data in order to match with the converting device 10. Regarding to different kinds of data, the glasses 20 may perform different processes as follows.

If the first detecting module 102 of the converting device 10 determines that the first information is not encrypted information and the second detecting module 103 determines that the first information is the information in the preset format, the first security module 105 encrypts the first information to obtain a first encrypted data, and sends the first encrypted data to the second transmitting module 106 for being transmitted. At this time, the communication module 203 is configured to establish a communication connection with the second transmitting module 106 of the converting device, and to receive the first encrypted data after establishing the communication connection.

The second security module 202 is configured to decrypt the first encrypted data so as to obtain the first information which is not encrypted information after the first encrypted data is received by the communication module 203, and further to send a displaying instruction to the displaying module 201 after obtaining the first information which is not encrypted information.

The displaying module 201 is configured to receive the displaying instruction, and to display according to the displaying instruction and the first information which is not encrypted information.

If the first detecting module 102 of the converting device 10 determines that the first information is not encrypted information and the second detecting module 103 determines that the first information is not the information in the preset format, the converting module 104 of the converting device 10 converts the first information into the first converted information in the preset format, and the first security module 105 encrypts the first converted information so as to obtain the first encrypted and converted information and sends the first encrypted and converted information to the second transmitting module 106 for being transmitted. At this time, the communication module 203 receives the first encrypted and converted data.

The second security module 202 is configured to decrypt the first encrypted and converted data so as to obtain the first converted information after the first encrypted and converted data is received by the communication module 203, and further to send a displaying instruction to the displaying module 201 after obtaining the first converted information.

The displaying module 201 is configured to receive the displaying instruction, and to display according to the displaying instruction and the first converted information.

If the first detecting module 102 of the converting device 10 determines that the first information is encrypted information, the first detecting module 102 sends the first information to the first security module 105 for being decrypted so as to obtain the first decrypted information, and if the second detecting module 103 determines that the first decrypted information is the information in the preset format, the first security module 105 encrypts the first decrypted information to obtain the second encrypted data, and sends the second encrypted data to the second transmitting module 106 for being transmitted. At this time, the communication module 203 receives the second encrypted data.

The second security module 202 is configured to decrypt the second encrypted data so as to obtain the first decrypted information after the second encrypted data is received by the communication module 203, and further to send a displaying instruction to the displaying module 201 after obtaining the first decrypted information.

The displaying module 201 is configured to receive the displaying instruction, and to display according to the displaying instruction and the first decrypted information.

If the first detecting module 102 of the converting device 10 determines that the first information is encrypted information, the first detecting module 102 sends the first information to the first security module 105 for being decrypted so as to obtain the first decrypted information, and if the second detecting module 103 determines that the first decrypted information is not the information in the preset format, the second detecting module 103 sends the first decrypted information to the converting module 104 for being converted, the converting module 104 converts the first decrypted information into the second converted information in the preset format, and the first security module 105 encrypts the second converted information to obtain the second encrypted and converted data and sends the second encrypted and converted data to the second transmitting module 106 for being transmitted. At this time, the communication module 203 receives the second encrypted and converted data.

The second security module 202 is configured to decrypt the second encrypted and converted data so as to obtain the second converted information after the second encrypted and converted data is received by the communication module 203, and further to send a displaying instruction to the displaying module 201 after obtaining the second converted information.

The displaying module 201 is configured to receive the displaying instruction, and to display according to the displaying instruction and the second converted information.

Accordingly, whichever kind among above four kinds of data is received, the glasses may perform the corresponding process for displaying. With the glasses 20 according to embodiments of the present disclosure, the encrypted data sent by the converting device 10 is decrypted by the second security module 202 in local, such that the safety of the data transmission is ensured, a remote attack from a hacker may be avoided to a maximum extent, and a hidden danger caused by sending data decrypted by other decrypting device to the glasses 20 may be eliminated.

In addition, in order to ensure the safety of the data output by the glasses 20, the second security module 202 of the glasses 20 is further configured to receive an input instruction, to generate information to be output according to the input instruction, and to encrypt the information to be output so as to obtain a second data. The communication module 203 is further configured to transmit the second data after the second data is obtained by the second security module 202. Accordingly, the information output by the glasses 20 is encrypted by the second security module 202 of the glasses 20 and then is transmitted by the communication module 203, such that the safety of the data output by the glasses 20 may be ensured.

At this time, the second transmitting module 106 of the converting device 10 further receives the second data, and sends the second data to the first security module 105. The first security module 105 decrypts the second data to obtain the second decrypted information after receiving the second data. If unencrypted information is transmitted between the terminal 30 and the converting device 10, the converting device 10 further sends the second decrypted information to the first transmitting module 101 for being transmitted. The terminal 30 receives the second decrypted information transmitted by the first transmitting module 101. If encrypted information is transmitted between the terminal 30 and the converting device 10, the first security module 105 of the converting device 10 encrypts the second decrypted information to obtain the third encrypted data after obtaining the second decrypted information, and sends the third encrypted data to the first transmitting module 101 for being transmitted. The terminal 30 receives the third encrypted data transmitted by the first transmitting module 101. At this time, the encryption algorithm for encrypting the second decrypted information should match with the decryption algorithm of the terminal 30. Of course, if the glasses 20 and the terminal 30 use the same encryption and decryption algorithms, the converting module 10 may directly transmit the second data sent by the glasses 20 to the terminal 30.

By encrypting the second decrypted information to obtain the third encrypted data for being transmitted to the terminal 30, the transmission safety of the data output by the glasses 20 may be ensured.

In order to further improve the safety of data transmission and to ensure the authenticity of the identity of the converting device 10, the converting device 10 may further sign a signature on the data to be transmitted and the glasses may further verify the signature signed by the converting device 10. Specifically, the identity may be verified by the following ways.

(1) If the first detecting module 102 of the converting device 10 determines that the first information is not encrypted information and the first information is the information in the preset format, the first detecting module 102 encrypts the first information to obtain the first encrypted data, and sends the first encrypted data to the second transmitting module 106 for being transmitted. At this time, the first security module 105 at least signs a signature on the first encrypted data to obtain a first signature data, and sends the first signature data to the second transmitting module 106 for being transmitted.

The communication module 203 of the glasses 20 further receives the first signature data when receiving the first encrypted data. The second security module 202 is configured to verify the first signature data after the first signature data is received by the communication module 203, and to decrypt the first encrypted data so as to obtain the first information which is not encrypted information after the first signature data is successfully verified.

(2) If the first detecting module 102 of the converting device 10 determines that the first information is not encrypted information and the first information is not the information in the preset format, the converting device 10 converts the first information into the first converted information in the preset format, encrypts the first converted information to obtain the first encrypted and converted data, and sends the first encrypted and converted data to the second transmitting module 106 for being transmitted. At this time, the first security module 105 at least signs a signature on the first encrypted and converted data to obtain a first signature data, and sends the first signature data to the second transmitting model 106 for being transmitted.

The communication module 203 of the glasses 20 further receives the first signature data when receiving the first encrypted and converted data. The second security module 202 is configured to verify the first signature data after the first signature data is received by the communication module 203, and to decrypt the first encrypted and converted data to obtain the first converted information after the first signature data is successfully verified.

(3) If the first detecting module 102 of the converting device 10 determines that first information is encrypted information, the first detecting module 102 sends the first information to the first security module 105 for being decrypted so as to obtain the first decrypted information, and if the first detecting module 102 determines that the first decrypted information is the information in the preset format, the first detecting module 102 encrypts the first decrypted information to obtain the second encrypted data, and sends the second encrypted data to the second transmitting module 106 for being transmitted. At this time, the first security module 105 at least signs a signature on the second encrypted data to obtain a first signature data, and sends the first signature data to the second transmitting module 106 for being transmitted.

The communication module 203 of the glasses 20 further receives the first signature data when receiving the second encrypted data. The second security module 202 is configured to verify the first signature data after the first signature data is received by the communication module 203, and to decrypt the second encrypted data to obtain the first decrypted information after the first signature data is successfully verified.

(4) If the first detecting module 102 of the converting device 10 determines that the first information is encrypted information, the first detecting module 102 sends the first information to the first security module 105 for being decrypted so as to obtain the first decrypted information, and the second detecting module 103 sends the first decrypted information to the converting module 104 for being converted, the converting module 104 converts the first decrypted information into the second converted information in the preset format. The converting module 104 encrypts the second converted information to obtain the second encrypted and converted data, and sends the second encrypted and converted data to the second transmitting module 106 for being transmitted. At this time, the first security module 105 at least signs a signature on the second encrypted and converted data to obtain a first signature data, and sends the first signature data to the second transmitting module 106 for being transmitted.

The communication module 203 of the glasses 20 further receives the first signature data when receiving the second encrypted and converted data. The second security module 202 is configured to verify the first signature data after the first signature data is received by the communication module 203, and to decrypt the second encrypted and converted data to obtain the second converted information after the first signature data is successfully verified.

In the above four ways, by signing a signature on the encrypted data and verifying the signature, the verification steps may be reduced, and thus the processing speed may be improved. Also, only if the signature is successfully verified, the encrypted data will be decrypted. Otherwise, if the signature is unsuccessfully verified, the encrypted data will not be decrypted to ensure the safety of the data.

(5) If the first detecting module 102 of the converting device 10 determines that the first information is not encrypted information, and the first information is the information in the preset format, the first detecting module 102 encrypts the first information to obtain the first encrypted data, and sends the first encrypted data to the second transmitting module 106 for being transmitted. At this time, the first security module 105 at least signs a signature on the first information which is not encrypted information to obtain a first signature data, and sends the first signature data to the second transmitting module 106 for being transmitted.

The communication module 203 of the glasses 20 further receives the first signature data when receiving the first encrypted data. The second security module 202 is configured to decrypts the first encrypted data to obtain the first information which is not encrypted information after the first signature data is received by the communication module 203, to verify the first signature data after the first information which is not encrypted information is obtained, and further to send a displaying instruction to the displaying module after the first signature data is successfully verified.

(6) If the first detecting module 102 of the converting device 10 determines that the first information is not encrypted information and the first information is not information in the preset format, the converting module 104 of the converting device 10 converts the first information into the first converted information in the preset format. The converting module 104 encrypts the first converted information to obtain the first encrypted and converted data, and sends the first encrypted and converted data to the second transmitting module 106 for being transmitted. At this time, the first security module 105 at least signs a signature on the first converted information to obtain a first signature data, and sends the first signature data to the second transmitting module 106 for being transmitted.

The communication module 203 of the glasses 20 further receives the first signature data when receiving the first encrypted and converted data. The second security module 202 is configured to decrypt the first encrypted and converted data to obtain the first converted information after the first signature data is received by the communication module 203, to verify the first signature data after the first converted information is obtained, and further to send a displaying instruction to the displaying module after the first signature data is successfully verified.

(7) If the first detecting module 102 of the converting device 10 determines that the first information is encrypted information, the first detecting module 102 sends the first information to the first security module 105 for being decrypted so as to obtain the first decrypted information, and if the first detecting module 102 determines that the first decrypted information is the information in the preset format, the first detecting module 102 encrypts the first decrypted information to obtain the second encrypted data, and sends the second encrypted data to the second transmitting module 106 for being transmitted. At this time, the first security module 105 at least signs a signature on the first decrypted information to obtain a first signature data, and sends the first signature data to the second transmitting module 106 for being transmitted.

The communication module 203 of the glasses 20 further receives the first signature data when receiving the second encrypted data. The second security module 202 is configured to decrypt the second encrypted data to obtain the first decrypted information after the first signature data is received by the communication module 203, to verify the first signature data after obtaining the first decrypted information, and further to send a displaying instruction to the displaying module after the first signature data is successfully verified.

(8) If the first detecting module 102 of the converting device 10 determines that the first information is encrypted information, the first detecting module 102 sends the first information to the first security module 105 for being decrypted so as to obtain the first decrypted information. The second detecting module 103 sends the first decrypted information to the converting module 104 for being converted, and the converting module 104 converts the first decrypted information into the second converted information in the preset format. The converting module 104 encrypts the second converted information to obtain the second encrypted and converted data, and sends the second encrypted and converted data to the second transmitting module 106 for being transmitted. At this time, the first security module 105 at least signs a signature on the second converted information to obtain a first signature data, and sends the first signature data to the second transmitting module 106 for being transmitted.

The communication module 203 of the glasses 20 further receives the first signature data when receiving the second encrypted and converted data. The second security module 202 is configured to decrypt the second encrypted and converted data so as to obtain the second converted information after the first signature data is received by the communication module 203, to verify the first signature data after obtaining the second converted information, and further to send a displaying instruction to the displaying module after the first signature data is successfully verified.

In the above four ways, by decrypting the encrypted data to obtain the decrypted information and verifying the first signature data according to the decrypted information, the validity of the verification is improved. Even if the encrypted data and the signature are both falsified, it can be verified, such that the safety of data transmission and the authenticity of the identity of the converting device 10 may be ensured.

In order to further improve the safety of data transmission, and to ensure the authenticity of the identity of the glasses 20, the glasses 20 may further sign a signature on the data to be transmitted, and the converting device 10 may further verify the signature signed by the glasses 20. Specifically, the identity may be verified by any of the following ways.

(1) The second security module 20 of the glasses 20 is further configured to sign a signature on the information to be output so as to obtain a second signature data after generating the information to be output. The communication module 203 is further configured to transmit the second signature data after the second signature data is obtained by the second security module 202.

At this time, the second transmitting module 106 of the converting device 10 further receives the second signature data when receiving the second data, and sends the second signature data to the first security module 105. The first security module 105 decrypts the second data to obtain the second decrypted information after receiving the second data and the second signature data, and verifies the second signature data after obtaining the second decrypted information.

If unencrypted data is transmitted between the terminal 30 and the converting device 10, the first security module 105 of the converting derive 10 sends the second decrypted information to the first transmitting module 101 for being transmitted to the terminal 30 after the second signature data is successfully verified.

If encrypted data is transmitted between the terminal 30 and the converting device 10, the first security module 105 of the converting device 10 encrypts the second decrypted information to obtain the third encrypted data after the second signature data is successfully verified, and sends the third encrypted data to the first transmitting module 101 for being transmitted to the terminal 30.

By at least signing a signature on the information to be output by the glasses 20, the safety of the signature data is improved. It can be verified by the converting device 10 even if the second data and the second signature data are both falsified, such that the safety of data transmission and the authenticity of the identity of the glasses 20 may be ensured.

The converting device 10 obtains the second decrypted information by decrypting the second data and verifies the second signature data. Thus, the validity of verification is improved. Even if the encrypted data and the signature are both falsified, it can be verified, such that the safety of data transmission and the authenticity of the identity of the glasses 20 may be ensured.

(2) The second security module 202 of the glasses 20 is further configured to at least sign a signature on the second data to obtain a second signature data. The communication module 203 is further configured to transmit the second signature data after the second signature data is obtained by the second security nodule 202.

At this time, the second transmitting module 106 of the converting device 10 further receives the second signature data when receiving the second data, and sends the second signature data to the first security module 105. The first security module 105 verifies the second signature data after receiving the second data and the second signature data, and decrypts the second data to obtain the second decrypted information after the second signature data is successfully verified.

If unencrypted data is transmitted between the terminal 30 and the converting device 10, the first security module 105 of the converting device 10 sends the second decrypted information to the first transmitting module 101 for being transmitted to the terminal 30.

If encrypted data is transmitted between the terminal 30 and the converting device 10, the first security module 105 of the converting device 10 encrypts the second decrypted information to obtain the third encrypted data, and sends the third encrypted data to the first transmitting module 101 for being transmitted to the terminal 30.

By at least signing a signature on the second data by the glasses 20, the processing steps are reduced and the processing speed of data is increased.

By directly verifying the second signature data by the converting device 10 according to the second data, the verification steps are reduced and the processing speed of data is increased. Moreover, only if the signature is successfully verified, the second data will be decrypted. Otherwise, if the signature is unsuccessfully verified, the second data will not be decrypted so as to ensure the safety.

Surely, the body of the glasses 20 may be further provided with a button. At this time, the second security module 202 receives the input instruction via the button. For example, the displaying module 201 displays “whether to confirm the displayed information”, the user may press the button to send a confirmation instruction for informing the glasses 20 and/or the converting device 10 to display. By confirming via the hardware, the displaying problem due to a hijack of the software may be avoided.

The body of the glasses 20 may be further provided with a loudspeaker. When audio data is transmitted, the loudspeaker may announce according to the information obtained by the second security module 202, thus ensuring normal use for users.

Of course, functions executed by the modules of the present disclosure may be integrated in one chip. For example, the communication module 203 and the second security module 202 of the glasses 20 are integrated in one chip. By integrating the modules in one chip, the space of the glasses 20 is saved, and the volume of the glasses 20 is reduced. The functions executed by the second security module 202 may also be divided into related functions executed by several sub-modules, such as an encrypting and decrypting sub-module, a signing sub-module. In this way the processing speed may be improved. The second security module 202 may be a safety chip. The first transmitting module 101, the first detecting module 102, the second detecting module 103, the converting module 104, the first security module 105 and the second transmitting module 106 of the converting device may be integrated in one chip. By integrating the modules in one chip, the space of the converting device 10 is saved, and the volume of the converting device 10 is reduced. Similarly, the functions executed by the first security module 105 may also be divided into related functions executed by several sub-modules, such as an encrypting and decrypting sub-module, a signing sub-module. In this way the processing speed may be improved. Only if the effect and purpose of the present disclosure are achieved, it may be regarded within the scope of the present disclosure, regardless of a module configuration adopted by the converting device 10 and the glasses 20.

Any procedure or method described in the flow charts or described in any other way herein may be understood to comprise one or more modules, portions or parts for storing executable codes that realize particular logic functions or procedures. Moreover, advantageous embodiments of the present disclosure comprises other implementations in which the order of execution is different from that which is depicted or discussed, including executing functions in a substantially simultaneous manner or in an opposite order according to the related functions. This should be understood by those skilled in the art which embodiments of the present disclosure belong to.

It is understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It should be understood by those skilled in the art that all or part of the steps in the method of the above embodiments can be implemented by instructing related hardware via programs, the program may be stored in a computer readable storage medium, and the program includes one step or combinations of the steps of the method when the program is executed.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the phrases throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A converting device, comprising: a first transmitting module, a first detecting module, a second detecting module, a converting module, a first security module and a second transmitting module; wherein
the first transmitting module is configured to establish a communication connection and to receive a first information after establishing the communication connection;
the first detecting module is configured to judge whether the first information is encrypted information after the first information is received by the first transmitting module;
if the first information is not encrypted information, the first detecting module sends the first information to the second detecting module for being detected;
the second detecting module is configured to judge whether the first information is an information in a preset format after receiving the first information;
if the first information is the information in the preset format, the second detecting module sends the first information to the first security module for being encrypted, and the first security module encrypts the first information to obtain a first encrypted data and sends the first encrypted data to the second transmitting module for being transmitted; and/or
if the first information is not the information in the preset format, the second detecting module sends the first information to the converting module for being converted, the converting module converts the first information into a first converted information in a preset format and sends the first converted information to the first security module for being encrypted, and the first security module encrypts the first converted information to obtain a first encrypted and converted data and sends the first encrypted and converted data to the second transmitting module for being transmitted; and/or
if the first information is encrypted information, the first detecting module sends the first information to the first security module for being decrypted;
the first security module decrypts the first information to obtain a first decrypted information and sends the first decrypted information to the second detecting module for being detected;
the second detecting module is configured to judge whether the first decrypted information is an information in a preset format after receiving the first decrypted information;
if the first decrypted information is the information in the preset format, the second detecting module sends the first decrypted information to the first security module for being encrypted, and the first security module encrypts the first decrypted information to obtain a second encrypted data and sends the second encrypted data to the second transmitting module for being transmitted; and/or
if the first decrypted information is not the information in the preset format, the second detecting module sends the first decrypted information to the converting module for being converted, the converting module converts the first decrypted information into a second converted information in a preset format and sends the second converted information to the first security module for being encrypted, and the first security module encrypts the second converted information to obtain a second encrypted and converted data and sends the second encrypted and converted data to the second transmitting module for being transmitted.

2. The converting device according to claim 1, wherein
the second transmitting module is further configured to receive a second data, and to send the second data to the first security module; the first security module decrypts the second data to obtain a second decrypted information after receiving the second data, and sends the second decrypted information to the first transmitting module for being transmitted; or
the second transmitting module is further configured to receive a second data and to send the second data to the first security module; the first security module decrypts the second data to obtain a second decrypted information after receiving the second data, encrypts the second decrypted information to obtain a third encrypted data, and sends the third encrypted data to the first transmitting module for being transmitted.

3. The converting device according to claim 1, wherein
the first security module is further configured to at least sign a signature on the first encrypted data so as to obtain a first signature data, and to send the first signature data to the second transmitting module for being transmitted; or
the first security module is further configured to at least sign a signature on the first encrypted and converted data so as to obtain a first signature data, and to send the first signature data to the second transmitting module for being transmitted; or
the first security module is further configured to at least sign a signature on the second encrypted data so as to obtain a first signature data, and to send the first signature data to the second transmitting module for being transmitted; or
the first security module is further configured to at least sign a signature on the second encrypted and converted data so as to obtain a first signature data, and to send the first signature data to the second transmitting module for being transmitted.

4. The converting device according to claim 1, wherein
the first security module is further configured to at least sign a signature on the first information which is not encrypted information so as to obtain a first signature data, and to send the first signature data to the second transmitting module for being transmitted; or
the first security module is further configured to at least sign a signature on the first converted information so as to obtain a first signature data, and to send the first signature data to the second transmitting module for being transmitted; or
the first security module is further configured to at least sign a signature on the first decrypted information so as to obtain a first signature data, and to send the first signature data to the second transmitting module for being transmitted; or
the first security module is further configured to at least sign a signature on the second converted information so as to obtain a first signature data, and to send the first signature data to the second transmitting module for being transmitted.

5. The converting device according to claim 2, wherein
the second transmitting module is further configured to receive a second signature data when receiving the second data, and to send the second signature data to the first security module; the first security module verifies the second signature data after receiving the second data and the second signature data, decrypts the second data to obtain the second decrypted information after the second signature data is successfully verified, and sends the second decrypted information to the first transmitting module for being transmitted; or
the second transmitting module is further configured to receive a second signature data when receiving the second data, and to send the second signature data to the first security module; the first security module verifies the second signature data after receiving the second data and the second signature data, decrypts the second data to obtain the second decrypted information after the second signature data is successfully verified, encrypts the second decrypted information to obtain the third encrypted data and sends the third encrypted data to the first transmitting module for being transmitted.

6. The converting device according to claim 2, wherein
the second transmitting module is further configured to receive a second signature data when receiving the second data, and to send the second signature data to the first security module; the first security module decrypts the second data to obtain the second decrypted information after receiving the second data and the second signature data, verifies the second signature data after obtaining the second decrypted information, and sends the second decrypted information to the first transmitting module for being transmitted after the second signature data is successfully verified; or
the second transmitting module is further configured to receive a second signature data when receiving the second data, and to send the second signature data to the first security module; the first security module decrypts the second data to obtain the second decrypted information after receiving the second data and the second signature data, verifies the second signature data after obtaining the second decrypted information, encrypts the second decrypted information to obtain the third encrypted data after the second signature data is successfully verified, and sends the third encrypted data to the first transmitting module for being transmitted.

7. The converting device according to claim 1, wherein
the first transmitting module transmits data in any of following modes: an audio transmission mode, a USB transmission mode, a serial transmission mode, an NFC transmission mode, a Blue Tooth transmission mode, an infrared transmission mode, an optical transmission mode, a WIFI transmission mode, a GPRS transmission mode, a 3G transmission mode, and a GSM transmission mode; and
the second transmitting module transmits data in any of following modes: an audio transmission mode, a USB transmission mode, a serial transmission mode, an NFC transmission mode, a Blue Tooth transmission mode, an infrared transmission mode, an optical transmission mode, a WIFI transmission mode, a GPRS transmission mode, a 3G transmission mode, and a GSM transmission mode.

8. A displaying system, comprising a pair of glasses and a converting device; wherein
the converting device comprises: a first transmitting module, a first detecting module a second detecting module, a converting module, a first security module and a second transmitting module;
the first transmitting module is configured to establish a communication connection and to receive a first information after establishing the communication connection;
the first detecting module is configured to judge whether the first information is encrypted information after the first information is received by the first transmitting module;
if the first information is not encrypted information, the first detecting module sends the first information to the second detecting module for being detected;
the second detecting module is configured to whether the first information is an information in a preset format after receiving the first information;
if the first information is the information in the preset format, the second detecting module sends the first information to the first security module for being encrypted, and the first security module encrypts the first information to obtain a first encrypted data and sends the first encrypted data to the second transmitting module for being transmitted; and/or
if the first information is not the information in the preset format, the second detecting module sends the first information to the converting module for being converted, the converting module converts the first information into a first converted information in a preset format and sends the first converted information to the first security module for being encrypted, and the first security module encrypts the first converted information to obtain a first encrypted and converted data and sends the first encrypted and converted data to the second transmitting module for being transmitted;
and/or
if the first information is encrypted information, the first detecting module sends the first information to the first security module for being decrypted;
the first security module decrypts the first information to obtain a first decrypted information and sends the first decrypted information to the second detecting module for being detected;
the second detecting module is configured to judge whether the first decrypted information is an information in a preset format after receiving the first decrypted information;
if the first decrypted information is the information in the preset format, the second detecting module sends the first decrypted information to the first security module for being encrypted, and the first security module encrypts the first decrypted information to obtain a second encrypted data and sends the second encrypted data to the second transmitting module for being transmitted; and/or
if the first decrypted information is not the information in the preset format, the second detecting module sends the first decrypted information to the converting module for being converted, the converting module converts the first decrypted information into a second converted information in a preset format and sends the second converted information to the first security module for being encrypted, and the first security module encrypts the second converted information to obtain a second encrypted and converted data and sends the second encrypted and converted data to the second transmitting module for being transmitted,
the pair of glasses comprises a body, a displaying module disposed on the body, a second security module disposed on the body and a communication module disposed on the body,
the communication module is configured to establish a communication connection with the second transmitting module of the converting device and to receive the first encrypted data after establishing the communication connection;
the second security module is configured to decrypt the first encrypted data so as to obtain the first information which is not encrypted information after the first encrypted data is received by the communication module, and further to send a displaying instruction to the displaying module after obtaining the first information which is not encrypted information;
the displaying module is configured to receive the displaying instruction, and to display according to the displaying instruction and the first information which is not encrypted information;
or
the communication module is configured to establish a communication connection with the second transmitting module of the converting device and to receive the first encrypted and converted data after establishing the communication connection;
the second security module is configured to decrypt the first encrypted and converted data so as to obtain the first converted information after the first encrypted and converted data is received by the communication module, and further to send a displaying instruction to the displaying module after obtaining the first converted information;
the displaying module is configured to receive the displaying instruction, and to display according to the displaying instruction and the first converted information;
or
the communication module is configured to establish a communication connection with the second transmitting module of the converting device and to receive the second encrypted data after establishing the communication connection;
the second security module is configured to decrypt the second encrypted data so as to obtain the first decrypted information after the second encrypted data is received by the communication module, and further to send a displaying instruction to the displaying module after obtaining the first decrypted information;
the displaying module is configured to receive the displaying instruction, and to display according to the displaying instruction and the first decrypted information;
or
the communication module is configured to establish a communication connection with the second transmitting module of the converting device and to receive the second encrypted and converted data after establishing the communication connection;
the second security module is configured to decrypt the second encrypted and converted data so as to obtain the second converted information after the second encrypted and converted data is received by the communication module, and further to send a displaying instruction to the displaying module after obtaining the second converted information;
the displaying module is configured to receive the displaying instruction, and to display according to the displaying instruction and the second converted information.

9. The displaying system according to claim 8, wherein
the second security module is further configured to receive an input instruction, to generate an information to be output according to the input instruction, and to encrypt the information to be output so as to obtain the second data;
the communication module is further configured to transmit the second data after the second data is obtained by the second security module.

10. The displaying system according to claim 8, wherein
the communication module is further configured to receive the first signature data when receiving the first encrypted data;
the second security module is configured to verify the first signature data after the first signature data is received by the communication module, and to decrypt the first encrypted data so as to obtain the first information which is not encrypted information after the first signature data is successfully verified;
or
the communication module is further configured to receive the first signature data when receiving the first encrypted and converted data;
the second security module is configured to verify the first signature data after the first signature data is received by the communication module, and to decrypt the first encrypted and converted data so as to obtain the first converted data after the first signature data is successfully verified;
or
the communication module is further configured to receive the first signature data when receiving the second encrypted data;
the second security module is configured to verify the first signature data after the first signature data is received by the communication module, and to decrypt the second encrypted data so as to obtain the first decrypted information after the first signature data is successfully verified;
or
the communication module is further configured to receive the first signature data when receiving the second encrypted and converted data;
the second security module is configured to verify the first signature data after the first signature data is received by the communication module, and to decrypt the second encrypted and converted data so as to obtain the second converted data after the first signature data is successfully verified.

11. The displaying system according to claim 8, wherein
the communication module is further configured to receive the first signature data when receiving the first encrypted data;
the second security module is configured to decrypt the first encrypted data so as to obtain the first information which is not encrypted information after the first signature data is received by the communication module, to verify the first signature data after obtaining the first information which is not encrypted information, and further to send a displaying instruction to the displaying module after the first signature data is successfully verified;
or
the communication module is further configured to receive the first signature data when receiving the first encrypted and converted data;
the second security module is configured to decrypt the first encrypted and converted data so as to obtain the first converted information after the first signature data is received by the communication module, to verify the first signature data after obtaining the first converted information, and further to send a displaying instruction to the displaying module after the first signature data is successfully verified;
or
the communication module is further configured to receive the first signature data when receiving the second encrypted data;
the second security module is configured to decrypt the second encrypted data so as to obtain the first decrypted information after the first signature data is received by the communication module, to verify the first signature data after obtaining the first decrypted information, and further to send a displaying instruction to the displaying module after the first signature data is successfully verified;
or
the communication module is further configured to receive the first signature data when receiving the second encrypted and converted data;
the second security module is configured to decrypt the second encrypted and converted data so as to obtain the second converted information after the first signature data is received by the communication module, to verify the first signature data after obtaining the second converted information, and further to send a displaying instruction to the displaying module after the first signature data is successfully verified.

12. The displaying system according to claim 9, wherein
the second security module is further configured to at least sign a signature on the information to be output so as to obtain the second signature data after generating the information to be output;
the communication module is further configured to transmit the second signature data after the second signature data is obtained by the second security module.

13. The displaying system according to claim 9, wherein
the second security module is further configured to at least sign a signature on the second data so as to obtain the second signature data;
the communication module is further configured to transmit the second signature data after the second signature data is obtained by the second security module.

14. The displaying system according to claim 9, wherein the body is provided with a button and the second security module receives the input instruction via the button.

15. The displaying system according to claim 8, wherein the communication module transmits data to the second transmitting module in any of following modes: an audio transmission mode, a USB transmission mode, a serial transmission mode, an NFC transmission mode, a Blue Tooth transmission mode, an infrared transmission mode, an optical transmission mode, a WIFI transmission mode, a GPRS transmission mode, a 3G transmission mode, and a GSM transmission mode.

16. The displaying system according to claim 8, further comprising a terminal; wherein the terminal is configured to establish a communication connection with the first transmitting module of the converting device, and to send the first information to the first transmitting module after establishing the communication connection.

17. The displaying system according to claim 16, wherein
the terminal is further configured to receive the second decrypted information transmitted by the first transmitting module; or
the terminal is further configured to receive the third encrypted data transmitted by the first transmitting module.

18. The converting device according to claim 2, wherein
the first security module is further configured to at least sign a signature on the first encrypted data so as to obtain a first signature data, and to send the first signature data to the second transmitting module for being transmitted; or
the first security module is further configured to at least sign a signature on the first encrypted and converted data so as to obtain a first signature data, and to send the first signature data to the second transmitting module for being transmitted; or
the first security module is further configured to at least sign a signature on the second encrypted data so as to obtain a first signature data, and to send the first signature data to the second transmitting module for being transmitted; or
the first security module is further configured to at least sign a signature on the second encrypted and converted data so as to obtain a first signature data, and to send the first signature data to the second transmitting module for being transmitted.

19. The converting device according to claim 2, wherein
the first security module is further configured to at least sign a signature on the first information which is not encrypted information so as to obtain a first signature data, and to send the first signature data to the second transmitting module for being transmitted; or
the first security module is further configured to at least sign a signature on the first converted information so as to obtain a first signature data, and to send the first signature data to the second transmitting module for being transmitted; or
the first security module is further configured to at least sign a signature on the first decrypted information so as to obtain a first signature data, and to send the first signature data to the second transmitting module for being transmitted; or
the first security module is further configured to at least sign a signature on the second converted information so as to obtain a first signature data, and to send the first signature data to the second transmitting module for being transmitted.

20. The displaying system according to claim 9, wherein
the communication module is further configured to receive the first signature data when receiving the first encrypted data;
the second security module is configured to verify the first signature data after the first signature data is received by the communication module, and to decrypt the first encrypted data so as to obtain the first information which is not encrypted information after the first signature data is successfully verified;
or
the communication module is further configured to receive the first signature data when receiving the first encrypted and converted data;
the second security module is configured to verify the first signature data after the first signature data is received by the communication module, and to decrypt the first encrypted and converted data so as to obtain the first converted data after the first signature data is successfully verified;
or
the communication module is further configured to receive the first signature data when receiving the second encrypted data;
the second security module is configured to verify the first signature data after the first signature data is received by the communication module, and to decrypt the second encrypted data so as to obtain the first decrypted information after the first signature data is successfully verified;
or
the communication module is further configured to receive the first signature data when receiving the second encrypted and converted data;
the second security module is configured to verify the first signature data after the first signature data is received by the communication module, and to decrypt the second encrypted and converted data so as to obtain the second converted data after the first signature data is successfully verified.
